(19) United States
(12) Patent Application Publication
(10) Pub. No.: US 2020/0411202 A1
(43) Pub. Date: Dec. 31, 2020

(54) METHOD AND SYSTEM FOR ENABLING CLOUD COMMUNICATIONS WITH APPLIANCES

(71) Applicant: Frobot, Inc., Roanoke, VA (US)

(72) Inventors: Jeremiah O'Sullivan, Palo Alto, CA (US); Melissa Nelson, Jensen Beach, FL (US)

(21) Appl. No.: 16/912,528

(22) Filed: Jun. 25, 2020

Related U.S. Application Data
(60) Provisional application No. 62/866,385, filed on Jun. 25, 2019.

(51) Int. Cl. G16Y 40/35; G16Y 10/80; G16Y 20/20; G16Y 20/30; G16Y 30/00

(52) U.S. Cl. CPC G16Y 40/35; G16Y 10/80; G16Y 30/00; G16Y 20/30; G16Y 20/20

(57) ABSTRACT

A system and method for implementing a cloud communication apparatus within an appliance. The cloud communication apparatus may communicate with a remote server and transmit thereto data associated with the appliance. The cloud communication apparatus may also receive instructions from the remote server for executing various functions of the appliance. The system and method as provided herein provides a method for a user to safely install and efficiently provide power to the cloud communication apparatus, while reducing the complexity of maintaining and otherwise running the appliance.

This application claims priority to and the benefit of U.S. Provisional Patent Application No. 62/866,385 filed on Jun. 25, 2019 and titled “Method and System for Enabling Cloud Communications with Appliances”, the disclosure of which is hereby incorporated by reference herein in its entirety.

### BACKGROUND

Existing kitchen systems in restaurants are used to provide customers with a variety of food items. For example, many fast food restaurants offer their customers frozen shakes and soft serve ice cream. The soft serve ice cream machines often go off-line for service and regular maintenance. A soft-serve machine is typically down for 3 hours each day for heat treatment. a heat treatment system works through an overnight, timed heating and cooling program that safely maintains product for two weeks before complete disassembly and cleaning are required.

Typically, customers are disappointed when they are unable to order their shakes and ice-cream, especially as customers order through delivery services, rather than visiting the restaurants personally.

Most kitchen systems, such as a soft-serve machines, are complex machines that have basic human interfaces to provide status and error information (e.g., flashing LEDs, etc.) Most restaurant owners do not know how to interpret the status and error information because the information is inconvenient to access, difficult to browse, difficult to read and difficult to understand. Additionally, most kitchen systems are incapable of communicating with other kitchen systems or servers.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates exemplary confection machines, according to some embodiments;

FIG. 1B illustrates exemplary compatible kitchen devices, according to some embodiments;

FIG. 2 illustrates an exemplary cloud communications module installed in a confection machine, according to some embodiments;

FIG. 3 illustrates an expanded view of a cloud communications module, according to some embodiments;

FIG. 4 illustrates exemplary cables of a cloud communications module, according to some embodiments;

FIG. 5 illustrates an exemplary platform framework for facilitating cloud communications, according to some embodiments;

FIG. 6 illustrates a method for an installation procedure for a cloud communications module, according to some embodiments;

FIG. 7 illustrates a method for executing commands received at a cloud communication module, according to some embodiments; and

FIG. 8 illustrates a method for data acquisition and transmission by a cloud communications module, according to some embodiments.

### DETAILED DESCRIPTION

The following disclosure provides different embodiments, or examples, for implementing different features of the subject matter. Specific examples of components and arrangements are described below to simplify the present disclosure. These are, of course, merely examples and are not intended to be limiting.

The present system and method are directed to installing a safe and low-power electronic communication and monitoring system for enhancing new and existing kitchen and dispensary appliances, such as confection machines, common culinary devices and other industrial equipment. The system may include a computing device installable into an appliance for facilitating communication with a cloud platform running on a remote server. The computing device may monitor, store, and process data in real-time from the appliance and transmit to the cloud platform. The computing device may also receive instructions from the cloud platform for controlling or otherwise providing to the appliance to execute various functions thereof.

The cloud platform may further provide user accounts for users of the platform to access functionalities or receive notifications related to the cloud platform and the appliances connected thereto. The cloud platform may provide for applications accessible over the web that enable convenient tools such as appliance statuses, alerts and notifications, predictions, suggestions, or any other system-related information and may do so either simultaneously with webpage or application data or through other communication methods such as SMS/MMS, email, or other cellular capabilities. The cloud platform may also implement data analytics to the data retrieved from the appliance, user account information, or other data residing in the system databases.

Generally, the present system and method provide improvements to the limited and simplistic interfaces of many appliances. The limited interfaces of appliances may lead to confusion in maintenance and repair of such devices. Furthermore, these limited interfaces fail to provide remote access to data provided by appliances, nor a method for remotely interacting with such interfaces. In other words, the present system provides for a universal master operating system for interfacing or otherwise communicating with kitchen appliances. In order to take advantage of such enhancements, the present disclosure provides for a man-in-the-middle (MITM) cable for securely inserting the computing device for reading and writing data to/from the control panel assembly of the appliance without risking the computing device to the external threats of the appliance's environment (e.g., users, employees, etc.). The present disclosure also provides for a safe and convenient apparatus for installing and powering the computing device, reducing a user's risk of meddling with the complex inner workings the appliance itself (e.g., loading food product, exposure to high voltage, etc.).

By installing the computing device into the appliance in a safe and efficient manner, the appliance may communicate with a cloud platform and users of the cloud platform, depending on the settings of the systems operator. After installation, the computing device may collect data from the appliance and use that data to predict malfunctions and breakdowns of the appliance. The present system collects and transmits information gathered from the appliance and can easily be expanded to include other types of monitoring systems within the kitchen or business associated thereto which, in turn, are automatically integrated into the inventive system and method to thereby become available online or worldwide via handheld devices or by phone. As such, it is intended that any monitoring device related to kitchen equipment can be connected to the system.

The following description provides specific details for a thorough understanding and an enabling description of these implementations. One skilled in the art will understand, however, that the disclosed system and methods may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the disclosed system and methods. Some frequently used terms are now described.

The phrases “in some examples,” “according to various examples,” “in the examples shown,” “in one example,” “for example,” “in other examples,” “various examples,” “some examples,” and the like (e.g., “embodiments”) generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “may,” “can,” “could,” or “might” be included or have a characteristic, that particular component or feature is not required to be included or have the characteristic.

The term “module” refers broadly to hardware modules, firmware modules, software modules stored on non-transitory storage medium (e.g., volatile or non-volatile memory for a computing device of the hardware), or any combination thereof. Modules are typically functional such that they that may generate useful data or other output using specified input(s). A module may or may not be self-contained. An application program (also called an “application”) may include one or more modules, or a module may include one or more application programs.

The preceding summary is provided for the purposes of summarizing some examples to provide a basic understanding of aspects of the subject matter described herein. Accordingly, the above-described features are merely examples and should not be construed as limiting in any way. Other features, aspects, and advantages of the subject matter described herein will become apparent from the following description of Figures and Claims.

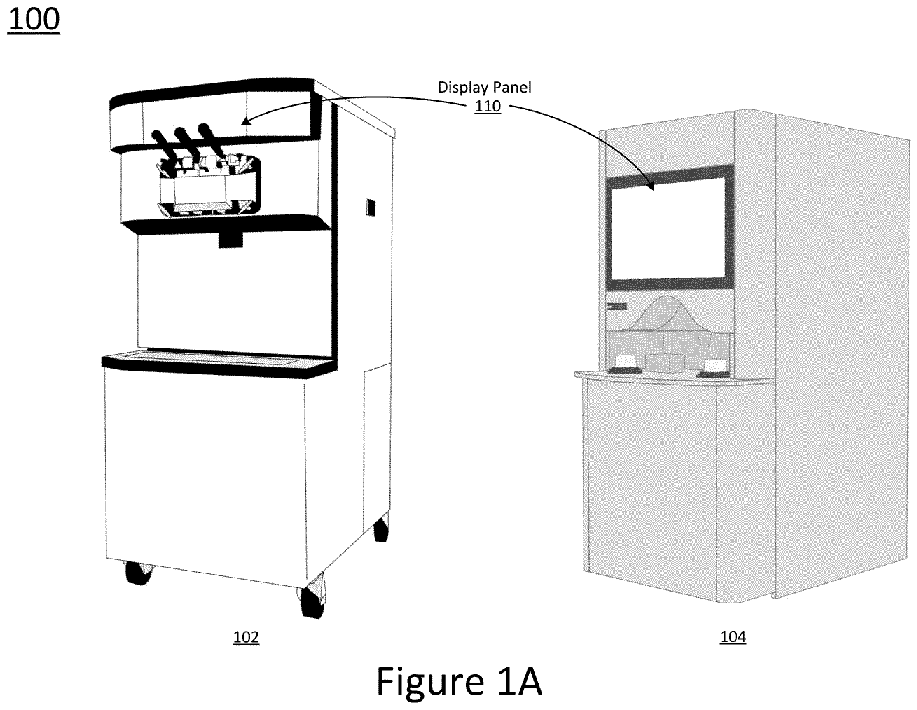

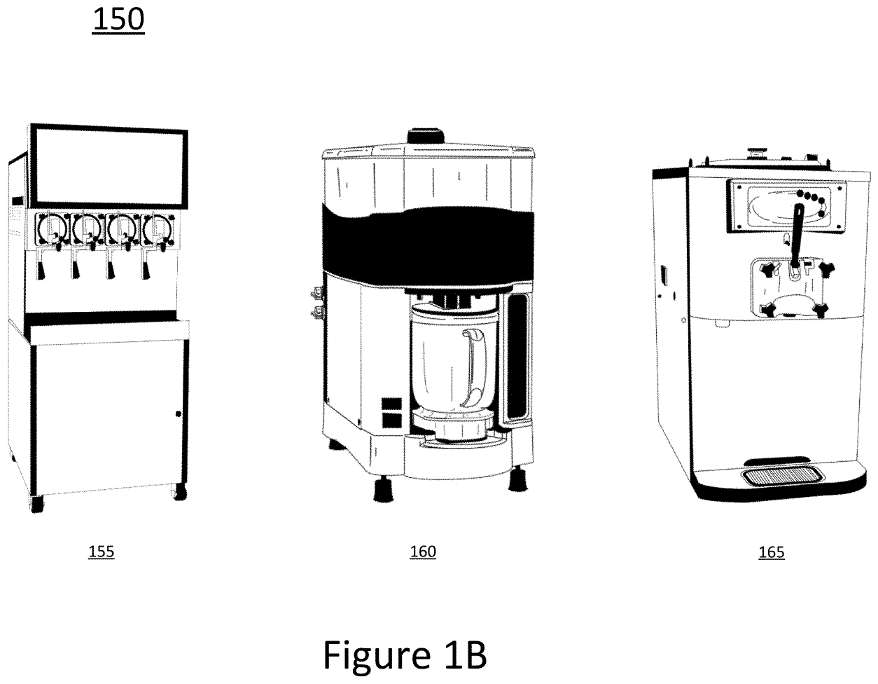

FIG. 1 illustrates exemplary confection machines, according to some embodiments. Confection machines 100 may be used to maintain, dispense, or otherwise facilitate the sale of the one or more products stored therein. According to some embodiments, the one or more products stored within confection machines 100 may include, but are not limited to, soft-serve ice cream, shakes and malts, frozen beverages, soft substances, frozen confections, or other frozen or near-frozen dispensable substances. According to other embodiments, the products stored within confection machines 100 may also include warm or hot substances including, but not limited to, warm coffee, hot chocolate, heated syrups, melted chocolate or other dispensable substances. Confection machines 100 may further include dispensable solids including, but not limited to, sprinkles, ground nuts, flavored toppings, or other hard products. Similarly, confection machines 100 may include dispensers for associated consumable and non-consumable products including, but not limited to, cones (e.g., consumable ice cream cones, paper-rolled cone cups, etc.), bowls, utensils, napkins, among others. Confection machines 100 may include one or more components for providing a user-friendly interface to dispense products, perform maintenance, or otherwise interact with the machines. According to some embodiments, interfaces provided by confection machines 100 may include a display panel 110. Confection machines 100 may take many forms, such as machine 102 and machine 104, and provide various interfaces. For example, machine 102 includes mechanical levers that, when actuated, release product below the associated spout. As another example, machine 104 includes a display panel 110 with touch-screen capabilities, providing the user with a wide-range of features. The interfaces of confection machines 100 may also provide additional peripherals for user interaction, including, but not limited to, hardware buttons, payment readers, cameras, among others.

FIG. 1B illustrates exemplary compatible kitchen devices, according to some embodiments. Other devices beyond machines 102 and 104 may be used in the present disclosure and, therefore, comprise various user interfaces. For example, other kitchen devices 150 compatible with the present disclosure may include, but are not limited to beverage dispenser machine 155, blending machine 160, and draught machine 165. Similar to confection machines 100, the interfaces of kitchen devices 150 provide a user with capabilities to actuate functions of the devices or otherwise perform maintenance thereto.

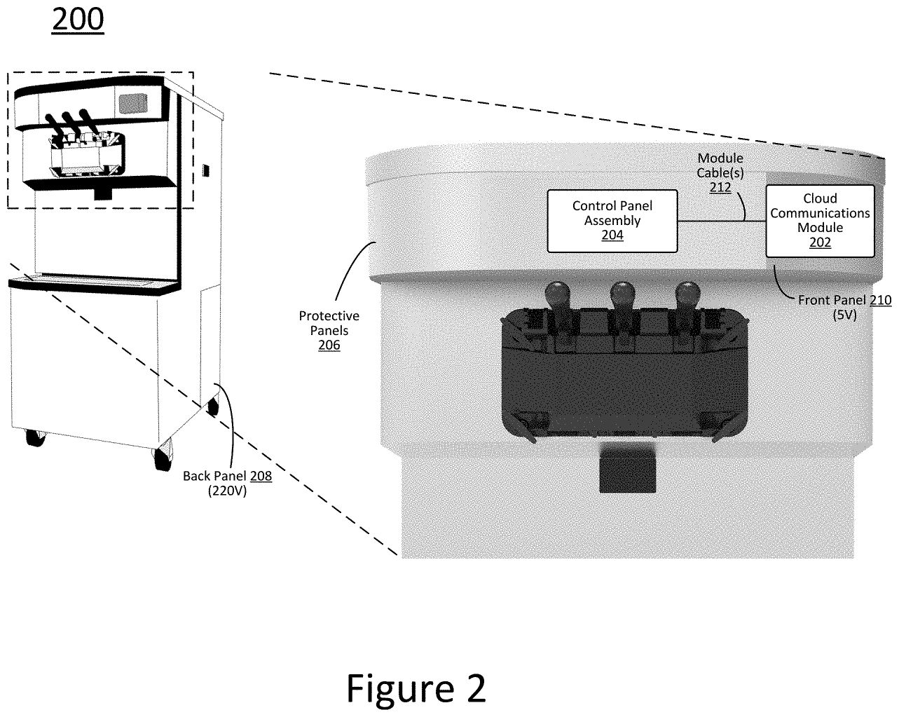

FIG. 2 illustrates an exemplary cloud communications module installed in a confection machine, according to some embodiments. A cloud communications module 202 may be installed at a strategic location within a confection machine (e.g., confection machines 100) or other kitchen devices (e.g., kitchen devices 150). According to some embodiments, cloud communications module 202 may be installed at a strategic location providing terminal access to control panel assembly 204 of the confection machine. Control panel assembly 204 may include a display interface board and a logic board. The interface board may receive commands from the interface of the confection machine and transmit those commands to the logic board. The logic board may include firmware used to operate the confection machine. According to some embodiments, the strategic location of cloud communications module 202 provides easy access to the control panel assembly 204 of the confection machine. For example, cloud communications module 202 may take advantage of the safeguards provided to control panel assembly 204, such as the encasing provided by the protective panels 206 of the confection machine. The strategic location of the cloud communications module 202 may further provide protection from any overflow or splatter from filling the confection machine with product, similar to the protection provided to control panel assembly 204. The strategic location of cloud communications module 202 also protects a user (e.g., employee, technician) during installation. For example, if cloud communications module 202 were installed by way of back panel 208, the installing user could be exposed to dangerous voltage levels (e.g., 220V) used to power the entire confection machine. By installing by way of front panel 210, the installing user risks exposure to the voltage of the control panel assembly 204 (e.g., 5V).

Communications module 202 may communicate with control panel assembly 204 to, gather, record, and otherwise monitor data associated with the operations of the confection machine in which the communications module 202 is installed. Communication between cloud communications module 202 and control panel assembly 204 may be facilitated by module cable(s) 212. Module cable(s) 212 may also provide power to cloud communications module 202. Upon receiving data, communications module 202 may process and transmit such data to a remote server through a network (e.g., the Internet).

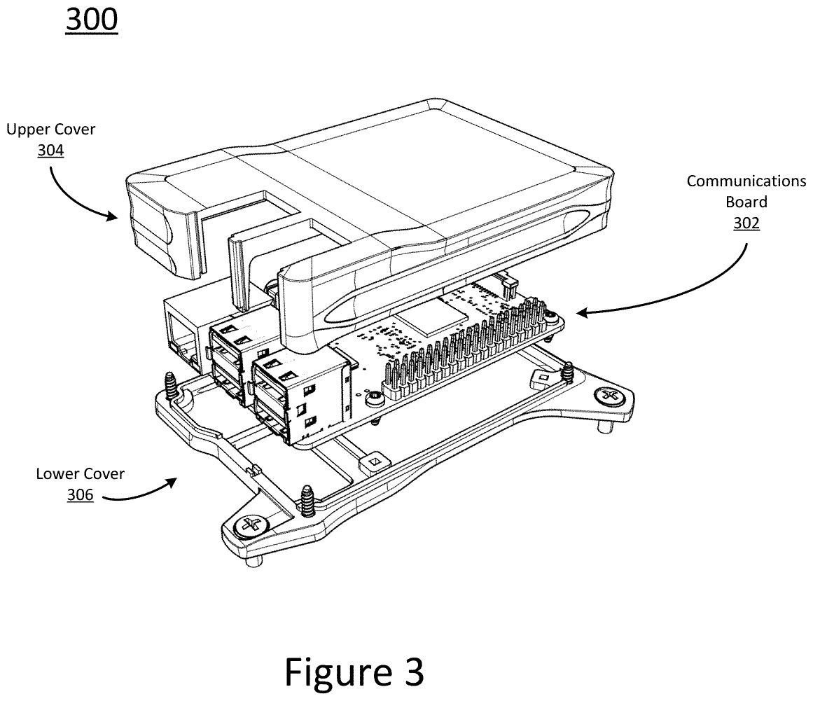

FIG. 3 illustrates an expanded view of a cloud communications module, according to some embodiments. Cloud communications module 300 may include a communications board 302, an upper cover 304, and a lower cover 306. Communications board 302 may be a circuit board, microcontroller, or other miniature computing device, according to some embodiments. Communications board 302 may also include at least two communication ports for data communications with the interface board and the logic board of the control panel assembly, as well as an input for receiving power from a power supply. Furthermore, communications board 302 may include a network communication chip set, through which it provides and receives data with a cloud server through a gateway and a network (e.g., the Internet). The network communication chip set may include wireless capabilities (e.g., Wi-Fi), wired capabilities (e.g., ethernet), or both. Communications board 302 may further include a cellular (e.g., 3G, 4G, LTE, 5G) communications chip set to reach the Internet and communicate with the remote server over a cellular connection.

Communications board 302 has firmware installed thereon that provides a man-in-the-middle (MITM) software module. The MITM software module may be used to record and process communication data between the interface board and the logic board of the confection machine's control panel assembly. Communications board 302 may be enclosed between upper cover 304 and lower cover 306. According to some embodiments, a board platform may be between lower cover 306 and communications board 302 to provide a mounting surface for communications board 302. Upper cover 304 and lower cover 306 may include openings for accessing ports of communications board 302, vents for heat dissipation, as well as screws to secure the entire cloud communications module 300 to a strategic location within the confection machine (e.g., on or near the control panel assembly 204).

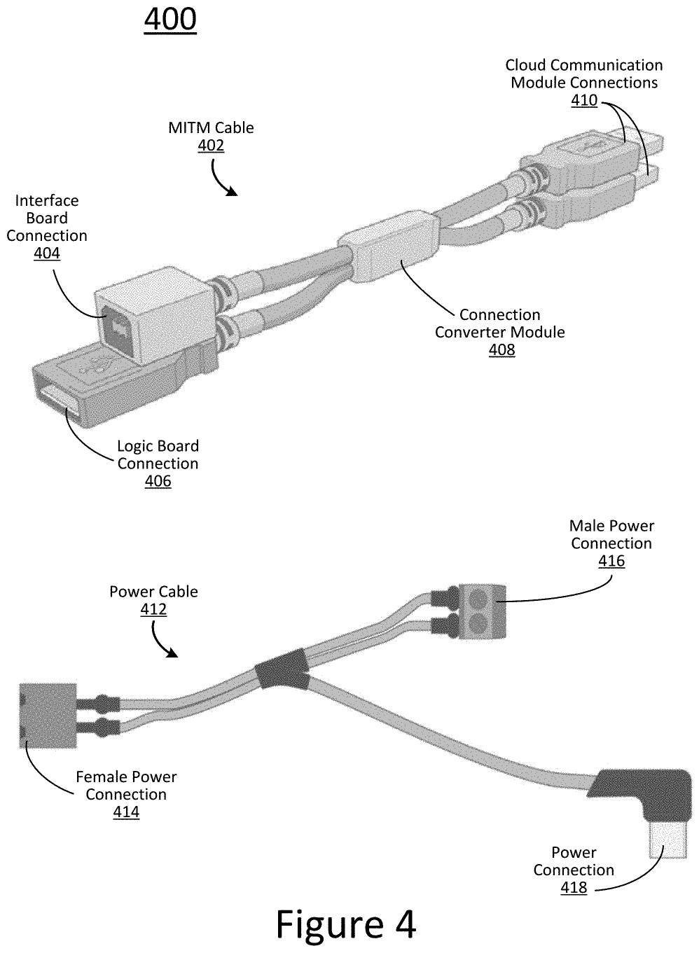

FIG. 4 illustrates exemplary cables of a cloud communications module, according to some embodiments. Cloud communications module cables 400 may include a man-in-the-middle (MITM) cable 402 and a power cable 412. The MITM cable 402 includes an interface board connection 404 and a logic board connection 406, each of which leads to one of the cloud communication module connections 408. Interface board connection 404 may connect the interface board of the control panel assembly to the cloud communication module through one of the cloud communication module connections 410. Similarly, the logic board connection 406 may connect the logic board of the control panel assembly to the cloud communication module through one of the cloud communication module connections 410.

According to some embodiments, MITM cable 402 may further include a connection converter module 408 for converting one connection type to another connection type. For example, as shown in MITM cable 402, connection converter module 408 converts the serial data (e.g., RS-485 protocol) received from interface board connection 404 (e.g., USB Type-B) to USB data to be passed to one of the cloud communication module connections 410 (e.g., USB Type-A) for processing and interpretation by the cloud communication module. Connection converter module 408 also encodes/converts the serial data (e.g., RS-485 protocol) received from logic board connection 406 to USB data to be passed to one of the cloud communication module connections 410 for interpretation by the cloud communication module. Similarly, connection converter module 408 encodes/converts the data having a USB protocol received from cloud communication module connections 410 to serial data (e.g., RS-485 protocol) for providing communications between the interface board and logic board. The connection converter module 408 decodes the RS-485 protocol of the control panel of the device to a USB protocol. Connection converter module 408 re-encodes the USB protocol messages to RS-485 protocol data to communicate back to the machine to tell it to turn on a certain mode, etc. Thus, MITM cable 402 routes all communication between the interface board and the logic board of the control panel through the cloud communication module. Thus, the cloud communication module is able to monitor and record the communication data between the interface board and the logic controller. In doing so, the cloud communication module may process the communication data locally and transmit to remote servers for further use.

The power cable 412 of the cloud communications module cables 400 includes an female power connection 414 and a male power connection 416 for mating with the original power supply originally used to provide power to the control panel assembly (e.g., control panel assembly 204) of the confection machine. The male power connection 416 may be plugged into the female power supply originally designated for the control panel assembly, while the female power connection 414 may receive the male power line plug of the control panel assembly. According to some embodiments, the male power line plug of the control panel assembly is plugged into the power supply prior to installation of the power cable 412, providing for convenient user installation of the power cable 412. According to some embodiments, power female power connection 414 and male power connection 416 may include various connection types, such as Amphenol® connectors, among others. Power cable 412 further includes a power connection 418 for providing power to the cloud communication module. According to some embodiments, power connection 418 may include various connection types including USB (e.g., USB Type-A, Type-B, Type-C, mini, micro, etc.), AC-DC barrel connector, voltage pins, among others. Communication board (e.g., 302) of cloud communications module may include a voltage regulator to regulate the power input according to the various connection types.

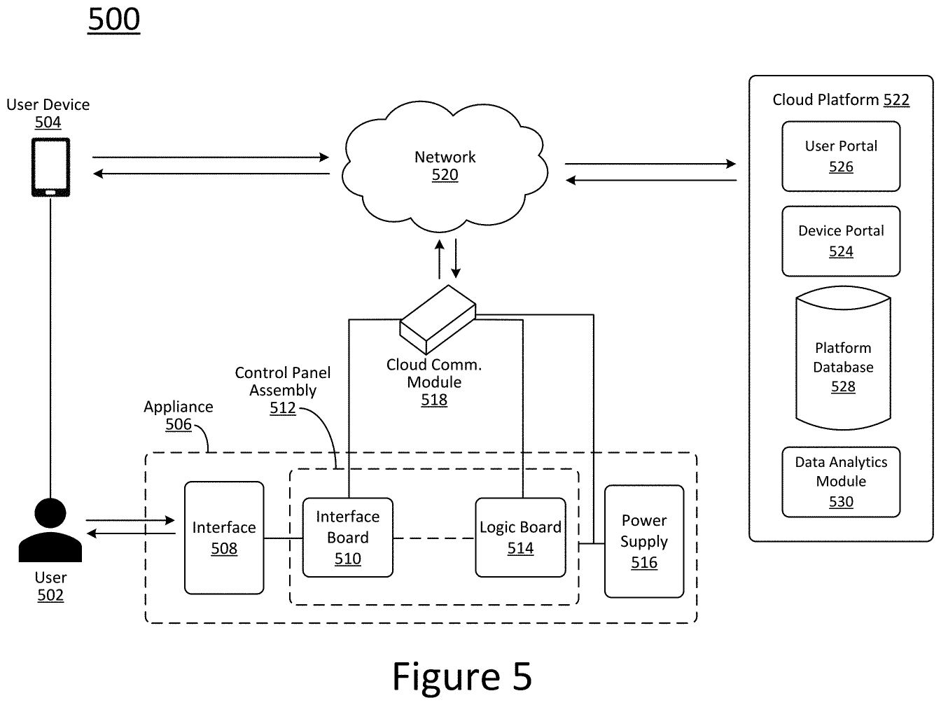

FIG. 5 illustrates an exemplary platform framework for facilitating cloud communications, according to some embodiments. According to some embodiments, platform framework 500 includes a user 502 with an associated user device 504. User 502 may interact with appliance 506 through interface 508 of appliance 506. According to some embodiments, user 502 may interact as a technician repairing or performing maintenance on appliance 506, an employee using or maintaining appliance 506, or a customer or any other user dispensing or otherwise using appliance 506, among others. According to some embodiments, appliance 506 may include, but is not limited to, confection machines (e.g., 100, 102, 104), kitchen devices (e.g., 150, 155, 160, 165), among other mechanical beverage and food dispensary systems.

Appliance 506 may include an interface 508, a control panel assembly 512 and a power supply 516. According to some embodiments, interface 508 may include, but is not limited to, a display panel (e.g., 110), hardware buttons, payment readers, cameras, among others. Control panel assembly 512 may comprise an interface board 510 and a logic board 514 for receiving input and facilitating the dispensing of stored product or other functionalities provided by appliance 506. Interface 508 is communicatively coupled to interface board 510 which, in turn, is communicatively coupled to logic board 514. For example, appliance 506 may receive input from user 502 by way of interface 508. Interface board 510 may process the data received from interface 508 and, in turn, transmits instructions to logic board 514 for facilitating the functionality provided by interface 508. Power supply 516 may provide power to control panel assembly 512. According to some embodiments, appliance 506 may comprise more than one power supply 516 for providing power to other components, including power supply 516 itself.

According to some embodiments, cloud communication module 518 may be installed by a user 502 (e.g., technician) in place of the communicative connection between interface board 510 and logic board 514. Cloud communication module 518 may be installed within appliance 506 near or approximate to control panel assembly 512. Alternatively, cloud communication module 518 may be installed approximate to appliance 506. After installation, cloud communication module may be installed to read and write data to/from the components of control panel assembly 512 (e.g., interface board 510, logic board 514). Cloud communication module 518 may be powered by power supply 516. Alternatively, cloud communication module 518 may be powered by other means, including, but not limited to, battery energy, solar energy, thermal energy, rotational or mechanical energy, kinetic energy, or any other power source. After installation, cloud communication module 518 may initiate an installation procedure. The installation procedure executed by cloud communication module 518 may include establishing a connection with network 520 (e.g., the Internet) through its network capabilities (e.g., Wi-Fi, ethernet, cellular network, among others).

According to some embodiments, cloud communication module 518 may communicate with cloud platform 522 via network 520. According to some embodiments, cloud platform 522 may be operated by a server. Cloud platform 522 may include a device portal 524, a user portal 526, and a platform database 528. Cloud communication module 518 may communicate with cloud platform 522 using device portal 524. Device portal 524 may facilitate communication with one or more cloud communication modules 518 associated with cloud platform 522. User portal 526 may facilitate communication with one or more user devices 504 of users 502.

Cloud communication module 518 may facilitate communication between interface board 510 and logic board 514 while reading, processing, and transmitting the data to cloud platform 522 via network 520. Alternatively, cloud communication module 518 may read data from the components of control panel assembly 512 without facilitating communication therebetween. Cloud communication module 518 may also read and process data locally while transmitting data in batches. Otherwise, cloud communication module 518 may also immediately transmit data for providing a constant stream of updated data to cloud platform 522. Cloud communication module 518 may further communicate with interface board 510 and logic board 514 by providing executable instructions or commands received from cloud platform 522 via network 520.

For example, according to some embodiments, during an installation procedure, cloud communication module 518 may receive a authentication code from cloud platform 522. Cloud communication module 518 may instruct interface board 510 to display the authentication code on the display panel of interface 508 in order to present user 502 with the authentication code. User device 504 may receive the authentication code as input from user 502. User device 504 may transmit the received authentication code to device portal 524 of cloud platform 522 via network 520. User device 504 may facilitate receiving and transmitting the authentication code by way of an application (e.g., web application, mobile application) associated with cloud platform 522 or otherwise through a cellular communication method (e.g., SMS/MMS, phone call, etc.). Upon matching the authentication code received from user device 504 to authentication code provided to cloud communication module 518, cloud platform 522 may assign cloud communication module 518 to a user account associated with user 502.

As another example, a display panel of interface 508 may display text to indicate that in order to make a purchase, user 502 may download a mobile application or access a web application on user device 504 and input a code into the machine. Once user 502 has entered the code into the mobile or web application, appliance 506 may indicate that it is ready to dispense product.

User device 504 may be used by user 502 to access services provided user portal 526 of cloud platform 522 over network 520. According to some embodiments, services provided by user portal 526 may depend on the user account privileges of the associated user (e.g., technician, client, customer, etc.). For example, user 502 may act as a technician or client of cloud platform 522 in initiating the installation process of cloud communication module 518 by providing the authentication code to cloud platform 522 through user device 504. Similarly, user 502 may act as a customer or any other user by interacting with appliance 506 by way of interface 508 or otherwise interacting with appliance 506 by way of cloud platform 522 using user device 504 over network 520. For example, as a customer, user 502 may be able to transmit a message (e.g., via SMS/MMS, web application, mobile application, etc.) to user portal 526 of cloud platform 522 to process a transaction and initiate a procedure on cloud communication module 518 to instruct appliance 506 to dispense product stored therein.

According to some embodiments, when executing instructions, cloud communication module 518 may ignore inputs received by interface board 510 in order to lock or otherwise ignore inputs provided by interface 508. Cloud communications module 518 may further instruct interface board 510 to display or otherwise indicate via interface 508 that the cloud communication module 518 is performing actions on appliance 506 or otherwise providing instructions to logic board 514. According to some embodiments, instructions provided by communication module 518 to logic board 514 may mimic instructions provided by interface board 510. Similarly, instructions provided by communication module 518 to interface board 510 may mimic instructions provided by interface board 510. For example, a display panel of interface 508 may display “Syncing” while the cloud communication module 518 ignores inputs received by interface board 510 and transmits instructions to logic board 514.

According to some embodiments, cloud communications module 518 may include a data determination layer to process or otherwise determine which received information may be necessary to transmit to cloud platform 522. Alternatively, cloud communications module 518 may transmit data to cloud platform 522 immediately without any additional steps (e.g., processing, storing, or otherwise determining which data to send) in order to assure that cloud platform 522 has instant access to the most up-to-date information related to appliance 506. According to some embodiments, the data determination layer may be programmed or otherwise arranged to determine the most efficient time to transmit data, which data may be marked as useful or necessary for transmission, among other determining factors. The data determination layer may be programmed or updated according to instructions provided by cloud platform 522. Alternatively, the data determination layer may be pre-programmed.

For example, a data determination layer may be programmed to gather data received from interface board 510, including button selections, LEDs, text displayed on display panel, and the hours displayed on display panel, as well as temperature data from logic board 514 and any available error data since last transmission. The data determination layer may then be programmed to transmit the gathered data every minute to cloud platform 522 via network 520 and device portal 524 for storage in platform database 528. The data determination layer may pre-process the gathered data to determine whether or not the gathered data is useful or necessary for transmission by comparing temperature data from the previous minute. If temperatures have not fluctuated over the one minute periodic interval, the data determination layer may not transmit the data to cloud platform 522 because it has not detected a change in temperature. According to another example, a data determination layer may detect deltas in data across the components of control panel assembly 512 (e.g., interface board 510, logic board 514) for transmission to cloud platform 522. In doing so, cloud platform 522 may track any and all changes within appliance 506.

Cloud communication module 518 may gather data associated with the functionality of appliance 506 including, but not limited to: hopper temperatures, barrel temperatures, viscosity, heat cleaning cycles (times, peak temperatures, holding times), wash cleaning cycles, any alerts/errors that may occur, and all other settings associated thereto. Cloud communication module 518 may also gather data associated with real-time information received by appliance 506 including, but not limited to, what button is pressed, time at which the button is pressed, and the results of that button press. Cloud communication module 518 may transmit this and any other data related to appliance 506 to cloud platform 522 over network 520 where it is stored platform database 528.

According to some embodiments, data received by cloud communication module 518 from components of control panel assembly 512 may include, but are not limited to, the following machine messages:

ARROW_DOWN;

SEL;

RIGHT_MENU;

ARROW_UP;

CLOSE_MENU;

WASH_RIGHT;

WASH_LEFT;

STANDBY_LEFT;

STANDBY_RIGHT;

AUTO_RIGHT;

AUTO_LEFT;

TOPPING_HEATER_RIGHT;

TOPPING_HEATER_LEFT;

HEAT;

PUMP_RIGHT; and

PUMP_LEFT.

The following LED messages may be received by cloud communication module 518, among others:

WASH_RIGHT_LED_ON;

WASH_LEFT_LED_ON;

WASH_RIGHT_LED_OFF;

STANDBY_LEFT_ON; and

STANDBY_RIGHT_ON.

The following status messages may be received by cloud communication module 518, among others:

HOURS;

FREEZER LOCKED; and

ALARM BUZZER.

In addition to storing data records in platform database 528, cloud platform 522 may further process the data stored in platform database 528 using data analytics module 530. According to some embodiments, data analytics module 530 may generate notifications transmittable to user 502 via user portal 526 regarding predictions or other important events associated with appliance 506. For example, data analytics module 530 may predict that a component of appliance 506 will need to be replaced or is failing, generating a notification to transmit to user 502 (e.g., acting as the owner of appliance 506) via user portal 526. User 502 may receive the notification via a mobile device 504 (e.g., SMS/MMS, phone call) or by an application (e.g., web application, mobile application) used to communicate with user portal 526. Cloud platform 522 may also preemptively ship the proper component that needs to be replaced in order to assure limited down time of appliance 506. Platform database 528 may store data in encrypted form for security reasons as the stored data may be proprietary and/or personal (i.e., historical and user-specific) in nature. Cloud platform 522 may also provide an Application Programming Interface (API) for developing enhanced capabilities, expanding integrations, and providing additional remote features to developers and users.

According to some embodiments, data analytics module 530 may implement machine learning or other regression models to make predictions about appliance 506 or user accounts of cloud platform 522. For example, data analytics module 530 may consider many variables regarding appliance 506, including, but not limited to hopper temperatures, barrel temperatures, amperage, viscosity, heat treatment temperatures, time to complete a heat treatment cycle, reaction time to alleviating any errors that occur, power failures, compressor overloads, mix out, mix low, among others in order to make predictions therefrom. Similarly, data analytics module 530 may further implement classification models to generate predictions about applicant 506 or user accounts of cloud platform 522, according to some embodiments. Further still, anomalous appliance behavior, preference models, business analytics, an many other determinations may be generated from data analytics module 530, according to some embodiments.

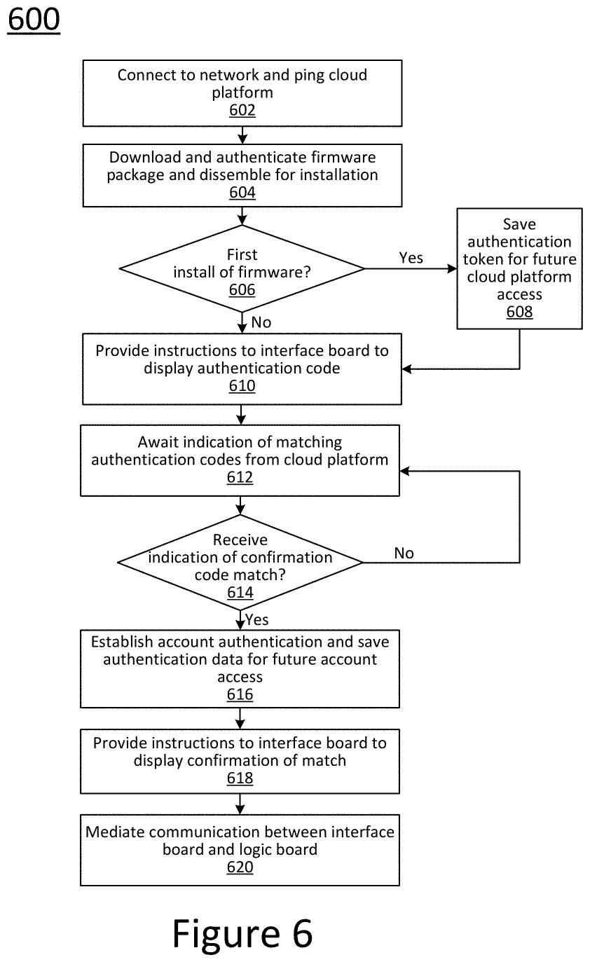

FIG. 6 illustrates a method for an installation procedure for a cloud communications module, according to some embodiments. Upon being connected to the control panel assembly of an appliance, cloud communication module may include connecting to a network (e.g., the internet) and pinging the cloud platform at 602. In order to connect to a network, cloud communication module may receive network credentials (e.g., Wi-Fi password) provided by a user or may otherwise be programmed to connect to a cellular network, according to some embodiments. According to some embodiments, cloud communication module may download and authenticate firmware from a cloud platform and dissemble for installation at 604. According to some embodiments, cloud communication module may have firmware pre-installed thereon. Installation procedure 600 may then determine whether this is the first installation of firmware at 606. If the firmware is being installed for the first time, installation procedure 600 may save an authentication token associated with the firmware at 608 for accessing the cloud platform in the future. Installation procedure 600 may then provide instructions to the interface board of the appliance to display an authentication code at 610. According to some embodiments, the authentication code may be provided by the firmware installed on cloud communication module or otherwise received over the network.

Upon displaying the authentication code, the installing user may transmit the authentication code to cloud platform by way of an application or SMS/MMS message, according to some embodiments. The cloud platform may receive the authentication code from the user and compare to the authentication code associated with the cloud communication module. Installation procedure 600 further includes awaiting an indication of matching authentication codes from cloud platform at 612. Once cloud communication module receives an indication of matching confirmation codes from cloud platform at 614, installation procedure 600 further includes establishing account authentication with the cloud platform and saving authentication data (authentication token) for future account access at 616. According to some embodiments, installation procedure 600 further includes providing instructions to the interface board to display for the installing user a confirmation of an authentication code match at 618. Installation procedure 600 also includes initiating a process to mediate communication between the interface board and the logic board of the control panel assembly of the appliance. In doing so, cloud communication module may execute remote commands, data acquisition, and transmission procedures, according to some embodiments.

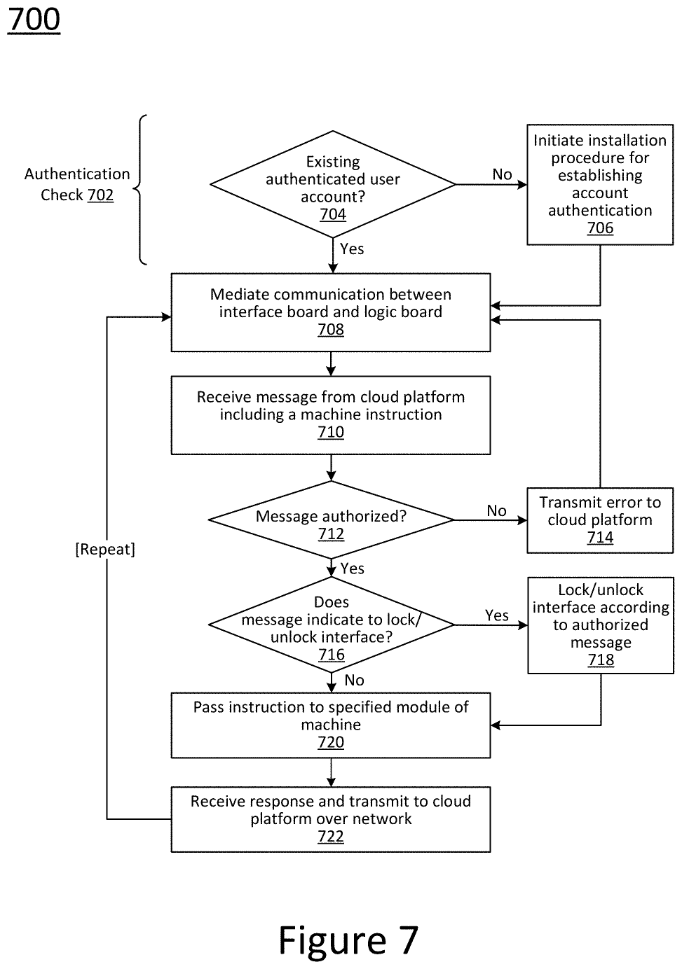

FIG. 7 illustrates a method for executing commands received at a cloud communication module, according to some embodiments. Once installed in an appliance, a cloud communication module may be able to execute remote commands procedure 700. According to some embodiments, remote commands procedure 700 may include an authentication check subprocess 702. Authentication check 702 includes confirming whether an existing user account has been authenticated for the cloud communication module at 704. If an existing user account has not been authenticated, remote commands procedure 700 may include initiating at least some of an installation procedure for establishing an authenticated account associated with the cloud communication module at 706. Remote commands procedure 700 may then instruct the cloud communication module to mediate communication between the interface board and the logic board of the control panel assembly of the appliance at 708. Remote commands procedure 700 further includes receiving a message from the cloud platform which indicates a machine instruction associated with the appliance at 710.

Remote commands procedure 700 also includes authorizing the message received from the cloud platform at 712 to confirm that it is an authentic message from the cloud platform. If the cloud communication module cannot authorize the message, it transmits an error to the cloud platform at 714 indicating an authorization failure. If the message is able to be authorized, the cloud communication module determines whether the message indicates to lock or unlock the interface at 716. If so, the cloud communication module instructs the interface board to lock or unlock the interface according to the authorized message at 718. For example, if the message indicates that the interface be locked, the cloud communication module instructs the interface board to lock the interface, but if the message indicates that the interface be unlocked, the cloud communication module instructs the interface board to unlock the interface. Remote commands procedure 700 further includes passing the instruction contained within the authorized message to the appropriate component(s) of the control panel assembly at 720. According to some embodiments, the cloud communication module may receive a response from the control panel assembly at 722 and, in turn transmit the response to the cloud platform over the network. Alternatively, the cloud communication module may not receive a response from the control panel assembly or otherwise may not transmit the response to the cloud platform. Thereafter, the cloud communication module may repeatedly execute the remote commands procedure 700 at various intervals of the procedure. For example, as shown in FIG. 7, remote commands procedure 700 initiates a repeated execution at 708 of remote commands procedure 700.

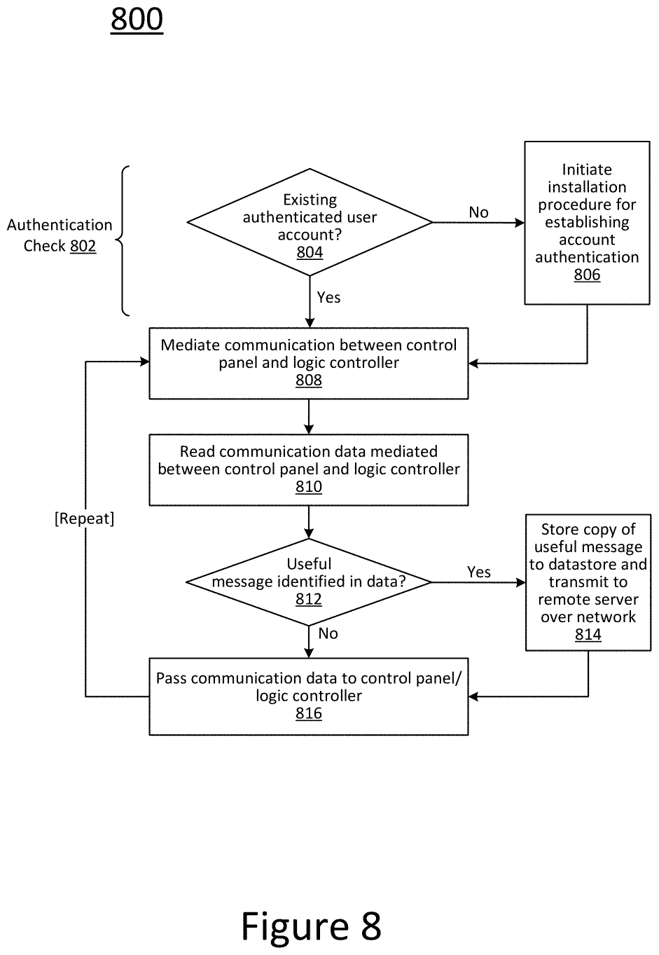

FIG. 8 illustrates a method for data acquisition and transmission by a cloud communications module, according to some embodiments. Once installed in an appliance, a cloud communication module may be able to a data acquisition and transmission procedure 800. According to some embodiments, acquisition and transmission procedure 800 may include an authentication check subprocess 802. Authentication check 802 includes confirming whether an existing user account has been authenticated for the cloud communication module at 804. If an existing user account has not been authenticated, acquisition and transmission procedure 800 may include initiating at least some of an installation procedure for establishing an authenticated account associated with the cloud communication module at 806. Data acquisition and transmission procedure 800 may then instruct the cloud communication module to mediate communication between the interface board and the logic board of the control panel assembly of the appliance at 808.

Acquisition and transmission procedure 800 further includes reading communication data mediated between the control panel and the logic controller at 810. Upon reading the communication data, the cloud communication module may identify which data of the communication data meets the criteria for transmission stored on the cloud communication module. If a message in the data is identified as useful, cloud communication module may store a copy of the useful message and transmit in batches to the cloud platform over a network at 814. Alternatively, the cloud communication module may transmit the useful message immediately upon identification, according to some embodiments. For example, if the criteria for transmission includes transmitting deltas in data received from the interface board over five minute increments, the cloud communication module may store or otherwise immediately transmit data received from the interface board that changes every five minutes. According to some embodiments, the cloud communication module may pass the communication data to the intended recipient of the data, such as the control panel or logic controller. Thereafter, the cloud communication module may repeatedly execute the acquisition and transmission procedure 800 at various intervals of the procedure. For example, as shown in FIG. 8, acquisition and transmission procedure 800 initiates a repeated execution at 808 of acquisition and transmission procedure 800.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program, or a collection of programs that carry out a specific function. In some examples, a service can be considered a server. The memory can be a non-transitory or transitory computer-readable medium.

In some examples the computer-readable storage devices, mediums, and memories can include a cable or wireless signal containing a bit stream and the like. However, when mentioned, transitory computer-readable storage media are media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Having now fully set forth examples and certain modifications of the concept underlying the present invention, various other examples as well as certain variations and modifications of the examples shown and described herein will obviously occur to those skilled in the art upon becoming familiar with said underlying concept.

We claim:

1. A computer-implemented method, comprising:
receiving, by a processer from the first output of a first embedded device of an appliance, a first set of data configured to be received at the input of a second embedded device;
receiving, by the processor from the second output of a second embedded device of the appliance, a second set of data configured to be received at the input of a first embedded device;
generating, by the processor, data of interest from the first set of data and the second set of data, wherein the data of interest comprises data that meet transmission preferences;
determining, by the processor, a time of transmission based on the transmission preferences;
providing, by the processor to the input of the second embedded device, the first set of data;
providing, by the processor to the input of the first embedded device, the second set of data; and
transmitting, by the processor and to a remote server, data of interest at the time of transmission.

2. The computer-implemented method of claim 1, wherein:
the first embedded device is an interface controller associated with the interface of the appliance; and
the second embedded device is a logic controller associated with controlling the logical functions of the appliance.

3. The computer-implemented method of claim 2, comprising:
receiving, by the processor and from a remote server, instructions associated with the appliance, wherein the instructions indicate one or more of machine-readable instructions and at least one executing device;
transmitting, by the processor and to the at least one executing device, the machine-readable instructions; and
receiving, by the processor and from the at least one executing device, a response to the machine-readable instructions; and
transmitting, by the processor and to the remote server, a confirmation that the instructions were successfully executed, wherein the confirmation may comprise the response.

4. The computer-implemented method of claim 3, further comprising:
identifying, by the processor, an interface status of the appliance as provided in the instructions; and
applying, by the processor and to the first embedded device, the interface status of the appliance until receiving the response.

5. The computer-implemented method of claim 4, wherein the interface status of the appliance is one of locked and unlocked.

6. The computer-implemented method of claim 2, wherein in determining data of interest comprises:
navigating, by the processor, a menu program as provided by one or more of the first embedded device and second embedded device of the appliance, wherein the menu program comprises menu pages;
extracting, by the processor, menu data by manipulating the menu program according to extraction procedure, wherein the extraction procedure copies data provided by the pages of the menu program; and
determining, by the processor, the menu data that meet the transmission preferences.

7. The computer-implemented method of claim 1, wherein the transmission preferences are provided by the remote server.

8. The computer-implemented method of claim 1, wherein the transmission preferences are associated with data characteristics that identify data for transmission to the remote server.

9. A non-transitory computer-readable medium storing instructions that, when executed by a processor, are operable to cause the processor to perform operations comprising:
receiving, from the first output of a first embedded device of an appliance, a first set of data configured to be received at the input of a second embedded device;
receiving, from the second output of a second embedded device of the appliance, a second set of data configured to be received at the input of a first embedded device;
generating data of interest from the first set of data and the second set of data, wherein the data of interest comprises data that meet transmission preferences;
determining a time of transmission based on the transmission preferences;
providing, to the input of the second embedded device, the first set of data;
providing, to the input of the first embedded device, the second set of data; and
transmitting, to a remote server, data of interest at the time of transmission.

10. The non-transitory computer-readable medium of claim 9, wherein:
the first embedded device is an interface controller associated with the interface of the appliance; and
the second embedded device is a logic controller associated with controlling the logical functions of the appliance.

11. The non-transitory computer-readable medium of claim 10, comprising:
receiving, from a remote server, instructions associated with the appliance, wherein the instructions indicate one or more of machine-readable instructions and at least one executing device;
transmitting, to the at least one executing device, the machine-readable instructions; and
receiving, from the at least one executing device, a response to the machine-readable instructions; and
transmitting, to the remote server, a confirmation that the instructions were successfully executed, wherein the confirmation may comprise the response.

12. The non-transitory computer-readable medium of claim 11, further comprising:
identifying an interface status of the appliance as provided in the instructions; and
applying, to the first embedded device, the interface status of the appliance until receiving the response.

13. The non-transitory computer-readable medium of claim 12, wherein the interface status of the appliance is one of locked and unlocked.

14. The non-transitory computer-readable medium of claim 10, wherein in determining data of interest comprises:
navigating a menu program as provided by one or more of the first embedded device and second embedded device of the appliance, wherein the menu program comprises menu pages;
extracting menu data by manipulating the menu program according to extraction procedure, wherein the extraction procedure copies data provided by the pages of the menu program; and
determining the menu data that meet the transmission preferences.

15. The non-transitory computer-readable medium of claim 9, wherein the transmission preferences are provided by the remote server.

16. The non-transitory computer-readable medium of claim 9, wherein the transmission preferences are associated with data characteristics that identify data for transmission to the remote server.
